(19) United States
(12) Patent Application Publication
(10) Pub. No.: US 2004/0005502 A1
(43) Pub. Date: Jan. 8, 2004

(54) Conductive component for electrochemical cells and a method for its manufacture

(76) Inventor: Harald Schlag, Ruesselsheim (DE)

Correspondence Address: CARY W. BROOKS, General Motors Corporation, Mail Code 482-C23-B21, P.O. Box 300, Detroit, MI, 48265-3000, US

(21) Appl. No.: 10/612,490

(22) Filed: Jul. 2, 2003

(30) Foreign Application Priority Data
Jul. 5, 2002 (DE) 102 30 395.9

(51) Int. Cl. H01M 4/66; B05D 5/12

(52) U.S. Cl. 429/245; 427/122

(57) ABSTRACT

A conductive component for electrochemical cells is described, in particular for use as a bipolar plate in a fuel cell. The conductive component consists of a metal part provided with a doped diamond coating and/or with a doped diamond-like carbon coating. This coating enables the component to be produced at favorable cost and nevertheless to satisfy the twin requirements of good corrosion resistance and high conductivity in the environment of an electrochemical cell. Methods for the manufacture of such a component by a CVD and/or by a PVD process are described and claimed as are coatings consisting of doped diamond and/or doped diamond-like carbon.

### TECHNICAL FIELD

The invention relates to a conductive component for electrochemical cells, in particular for use as a bipolar plate in a fuel cell, to a method for the manufacture of such a conductive component, to the use of such a conductive component and to a coating of a metal part for use in electrochemical cells.

### BACKGROUND OF THE INVENTION

Bipolar plates, also often termed gas separator plates, are used in fuel cells and form at opposite sides of a fuel cell a termination of the respective cell which is impermeable to gases and liquids, with one bipolar plate being present between each two adjacent fuel cells. In addition the bipolar plates of a stacked cell arrangement connect adjacent cells electrically to one another, so that the positive side of one cell simultaneously represents the negative side of the adjacent cell, which has led to the name “bipolar plate”. In order to achieve a high efficiency of the fuel cell, the bipolar plates must have a high electrical conductivity.

The corrosive gaseous, liquid or solid substances present in a fuel cell can attack the bipolar plates and corrode their surfaces. To counter this chemically resistant plates of graphite have been used as bipolar plates. As an alternative intrinsically corrosion resistant and conductive metallic materials such as stainless steel have been used for bipolar plates. However, with stainless steel and also with other intrinsically corrosion resistant metal materials, a thin oxide layer forms in an electrochemical cell or in a fuel cell. This oxide layer admittedly protects the component against further corrosion but is not conductive and thus hinders the conduction of current perpendicular to the areal extent of the component. In order to overcome this problem, it is known to coat bipolar plates of a material which is corrosion resistant per se with a noble metal such as gold or platinum. Such coatings admittedly protect against oxide formation and also lead to the required conductivity, however, they increase the manufacturing costs of the bipolar plates. Other coatings, such as for example a TiN coating are not sufficiently stable for use as a coating of a bipolar plate in a fuel cell.

A coating for the perfluorosulphonic acid membrane (Nafion™) of a PEM fuel cell is known from U.S. Pat. No. 5,624,718. This coating consists of a thin layer of diamond-like carbon material (DLC) which is doped with a fine distributed catalytically active substance, such as platinum or platinum-ruthenium. The purpose of the coating is to equip the porous Nafion™ membrane with the electro-catalytic activity necessary for low temperature fuel cells.

### SUMMARY OF THE INVENTION

In comparison to the prior art described above, it is the object underlying the invention to protect conductive components of a fuel cell in a cost favorable manner against oxide formation and simultaneously to ensure an adequate conductivity of the conductive components.

The object is satisfied in particular in that the conductive component comprises a metal part having a doped coating in the form of at least one of a doped diamond coating (DM coating) and a diamond-like carbon coating (DLC coating). Metal parts in an electrochemical cell, for example bipolar plates or current supply lines and extraction lines in a fuel cell are ideally protected to an adequate extent against oxide formation through such a coating and indeed also with a relatively thin coating in the range from 1 nm to 10 μm. Although thin coatings are frequently porous, this does not pose a problem in accordance with the invention since, when using an intrinsically corrosion resistant metal part, the oxide formation in the region of the pores protects against further corrosion of the layer and the lack of conductivity in these regions, which are present in distributed form, is not found to be disturbing for the electrical conduction within the fuel cells, which takes place perpendicular to the real extent of the bipolar plates.

At the same time, a conductivity can be achieved in the DM or DLC coating, as a consequence of the doping, i.e. as a consequence of the incorporation of foreign atoms, for example metal atoms, which ensures a high efficiency of the fuel cell. Moreover, favourably priced carbon sources, such as simple hydrocarbons can be used for the diamond or for the carbon of the DM or DLC coating, depending on the method of manufacture. The chemical stability of the DM or the DLC leads to an excellent resistance against aging. Moreover, the noble electrochemical potential of the carbon, ensures no oxidation of the contact surfaces takes place and thus that a low contact resistance is maintained to the elements which are in contact with the coated metal part of the invention in the electrochemical cell.

The diamond coating and/or the diamond-like carbon coating can be doped with foreign atoms of the main groups and/or the side groups of the periodic table and/or with the rare earths. This large number of possible dopants ensures a cost favourable manufacture of the metal part, with it being possible to ensure an adequate conductivity through a directed choice of the dopant or dopants.

The diamond coating and/or the diamond-like carbon coating can be doped with one or more of the elements Ti, W, Au. These foreign atoms lead, because of their own corrosion resistance, together with the diamond or diamond-like carbon, to a high resistance of the coating with respect to corrosive substances in the fuel cell and simultaneously ensure an adequately high conductivity.

The diamond coating and/or the diamond-like carbon coating can be further doped with one or more of the following elements: B, Sc, Y, Nb, V, Fe, Cr, Ni, Mn, Zr, Mo, Ta, Hf, Pt, Pd, Re, Ru, Rh, Ir, Ag in addition to the above listed elements.

The diamond coating and/or the diamond-like carbon coating can have between 0 and 35%, in particular approximately 10 to 20% foreign atoms. This proportion of foreign atoms ensures an adequate conductivity.

The diamond coating and/or the diamond-like carbon coating can, as indicated above, have a layer thickness between 0 and 10 μm, in particular approximately 1 to 150 nm. This layer thickness ensures an adequate conductivity of the metal part and leads to an adequate protection against oxide formation.

The metal part can be formed from titanium, stainless steel, steel, tin-plated steel, aluminium, magnesium, and/or an alloy thereof. Since at least some of these materials themselves have a considerable resistance to corrosion, a corrosion resistant electrically conductive component is achieved together with the coating of the invention.

The doped diamond coating and/or the doped diamond-like carbon coating may be produced by a CVD and/or a PVD process. Thus the formation of the diamond coating or of the diamond-like carbon coating and the doping of the respective coating can be carried out simultaneously, with a fine distribution of the dopant being moreover achieved. In addition simple, favourably priced, hydrocarbons such as methane or acetylene can be used in the CVD process as raw materials for the diamond or carbon of the coating. A further advantage lies in the fact that the CVD or PVD process can be carried out in a continuous treatment plant and in a manner suitable for large production series and can moreover be carried out in an environmentally friendly manner due to hermetic screening relative to the environment.

The CVD process and/or the PVD process can be carried out with plasma assistance. This is advantageous with respect to the deposition of the coating materials on the metal part and leads, in particular with the CVD process, to a coating with a high content of diamond or diamond-like carbon and a low content of impurities, such as for example non-reacted hydrocarbon.

When a CVD and/or PVD process is selected which involves the use of one or more reactive gases a carbon material or a dopant which is to be deposited on said metal part can be made available, fully or in part, as a component of said reactive gases and can be deposited on the metal electrode as a component of one or more reactive gases to form the desired doped DM and/or doped DLC coating.

The process can be carried out in a reaction chamber, with a pressure of 0.1 to 50000 Pa being set in the reaction chamber. In this manner a high degree of purity of the doped DM and/or DLC coating can be achieved.

The metal part of the above named kind is used in an electrochemical cell. Thus it can be ensured that the metal part is not attacked in the fuel cell by the corrosive substances present there and is simultaneously adequately conductive.

The metal part of the above-named kind is used as a bipolar plate in a fuel cell. In this way an areally extended oxide formation on the bipolar plate in the fuel cell is prevented and an ideal efficiency of a fuel cell is ensured at the same time because of the adequate conductivity.

The metal part of the kind set forth above is used as a bipolar plate in a fuel cell of one of the following kinds: PEMFC (Proton Exchange Membrane), DMFC (Direct Methanol Fuel Cell), SOFC (Solid Oxide Fuel Cell), MCFC (Molten Carbonate Fuel Cell), PAFC (Phosphoric Acid Fuel Cell) and AFC (Alkaline Fuel Cell).

A coating of the metal part for electrochemical cells, in particular of a bipolar plate for a fuel cell comprises doped diamond and/or doped diamond-like carbon. This leads to the above named advantages. In this respect the diamond and/or the diamond-like carbon can be doped with one or more of the foreign atoms Ti, W, Au, B, Sc, Y, Nb, V, Fe, Cr, Ni, Mn, Zr, Mo, Ta, Hf, Pt, Pd, Re, Ru, Rh, Ir, Ag.

Advantageous embodiments of the invention are set forth in the description, in the drawings and in the subordinate claims.

In the following, the invention will be described, clearly by way of example with reference to the accompanying drawings.

### BRIEF DESCRIPTION OF THE DRAWINGS

FIG. 1 is a schematic plan view of an embodiment of a metal part in accordance with the invention;

FIG. 2 is a cross-section through the embodiment shown in FIG. 1 along the line II-II;

FIG. 3 is a cross-section through the embodiment shown in FIG. 1 along the line III-III; and

FIG. 4 is a schematic cross-section of the section of two adjacent fuel cells with three examples of the embodiment shown in FIG. 1.

### DESCRIPTION OF THE PREFERRED EMBODIMENT

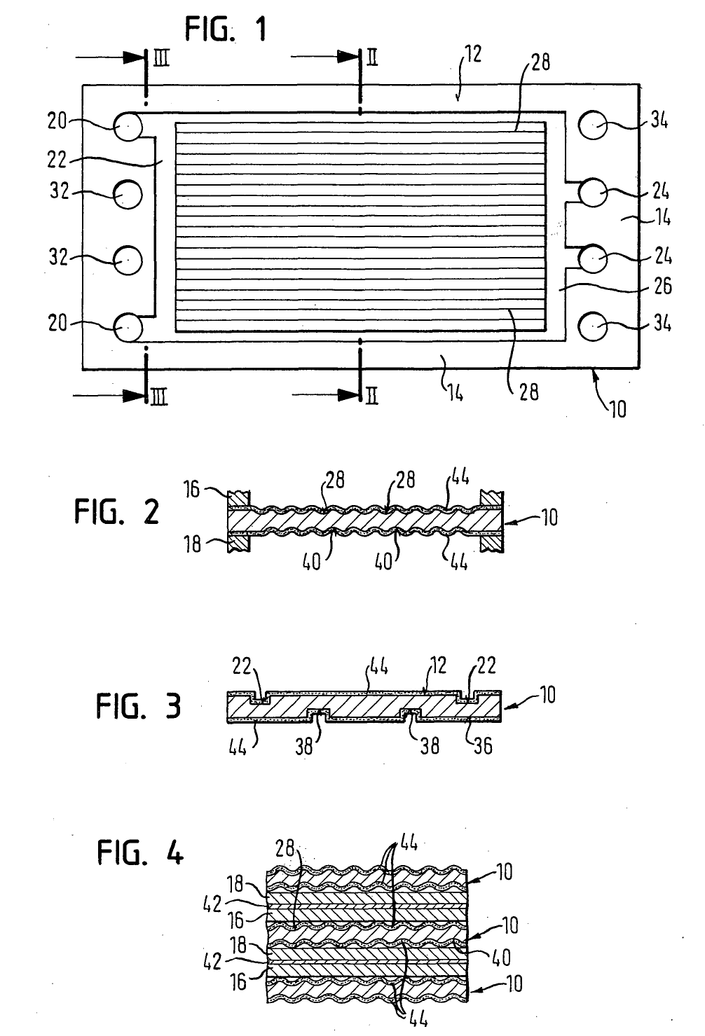

FIGS. 1 to 3 first show a metal part in accordance with the invention which is designed as a bipolar plate 10 for a fuel cell. The bipolar plate 10 is suitable for use in a fuel cell arrangement comprising a plurality of PEM fuel cells stacked on top of one another (as indicated in FIG. 4).

The present FIGS. 1 to 4 are simply schematic drawings, in order to explain the shaping of such a bipolar plate.

The top side 12 of the bipolar plate 10 of FIG. 1 is provided with a peripherally extending margin 14 which lies in a plane and which makes it possible to integrate the plate into a stack of plates and to ensure a sealed connection to upper and lower plates 16 to 18, which are only schematically shown in FIGS. 2 and 3. On the one side of the plate 10 are two supply openings 20, for example for air, which communicate with a recessed channel region 22. At the other side of the bipolar plate are two discharge openings 24 for non-consumed air and water vapour which communicate with a recessed channel region 26. Flow passages 28 extend in the longitudinal direction of the bipolar plate between the recessed channel region 22 and the recessed channel region 26 and enable air which is supplied via the supply openings 20 to flow from the left side of the plate to the right side to the discharge openings 24. In so doing this air comes into contact with catalytically coated surfaces arranged above the channels 28 of the plate 16 belonging to the membrane electrode assembly (MEA) and react there with protons in order to form water, with an electrical current being produced which flows through the bipolar plate 10.

The further openings 32 and 34 of the plate represents supply and discharge openings for hydrogen. These are separated at the upper and lower side 12 and 36 of the bipolar plate in FIG. 3, by regions of the plate which lie in the plane of the marginal frame 14, from the air supply and discharge openings 20 and 24 respectively and from the correspondingly recessed regions 22 and 26 and these are sealed off relative to the latter and relative to the external environment.

At the lower side 36 of the plate 10 there are, in accordance with FIG. 3, recessed channel regions in a region reversed relative to FIG. 1, i.e. the two supply openings 32 communicate with a recessed channel region 38 corresponding to the channel regions 26 on the upper side of the plate 10 whereas the two discharge openings 32 correspond with a (non-illustrated) recessed channel region which is formed in accordance with the channel region 22. The channel regions on the underside 36 of the plate 10 communicate with the longitudinal channels 40 formed in the lower side of the plate so that hydrogen can flow from the supply openings 32 to the discharge openings 34.

As shown in FIG. 4, the lower side of the bipolar plate 10 belongs to the neighbouring fuel cell and delivers protons to the membrane 42 of the cell, with the protons passing through the membrane and being reacted in the adjacent chamber with atmospheric oxygen, whereby a current arises on the one hand and water is produced on the other hand. The air flow in the neighbouring cell is made available by the lower bipolar plate 10 shown there in precisely the same manner as with the bipolar plate 10 of FIG. 1. In known manner a fuel cell, consisting of an anode (here the plate 16), a cathode (here the plate 18) and between them an electrolyte present in the form of a membrane (here the membrane 42) exists between each pair of neighbouring bipolar plates 10. The plates 16, 18 and the membrane lying between them form the above-mentioned so-called MEA.

The bipolar plate 10 is formed from stainless steel, it can however also be formed from titanium, steel, tin plated steel, aluminium, magnesium and/or an alloy of the named metals.

In order to achieve an ideal conductivity and for protection against corrosion, the bipolar plate 10 is covered with a diamond-like carbon coating 44 (DLC, Diamond Like Carbon) with a layer thickness of 1 to 150 nm, with this coating being doped with titanium in an amount from 10 to 20%. As an alternative or as an addition boron or other metal atoms of the main or side groups of the periodic table or of the rare earths can be incorporated as dopants in the DLC layer. Furthermore, the coating 44 of the bipolar plate 10 can contain diamond (DM, diamond) in addition to DLC or can consist of diamond and be doped with the named foreign atoms.

For the manufacture of the DLC coating 44 the uncoated bipolar plate 10 is subjected to a plasma assisted CVD (Chemical Vapour Deposition) process. For this purpose, the uncoated plate 10 is introduced into a reaction chamber and the reaction chamber is evacuated. High purity methane gas or another gaseous hydrocarbon is subsequently introduced with a carrier gas into the reaction chamber, and, depending on the size of the bipolar plate to be coated, as well as on the desired layer thickness, a chamber pressure of 0.1 to 50000 Pa is selected. The carrier gas and the methane gas are ionized by glow discharge and the plasma is produced. In known manner chemical reactions which are normally kinetically inhibited, or which first take place at very high temperatures, can take place at relatively low temperatures under plasma conditions. Through the application of a voltage to the plate 10 the coating process can be advantageously influenced. The ions in the plasma are accelerated onto the plate 10 and heat up the latter. As a consequence a reaction of the molecules of the methane gas on the plate 10 arises and the methane is deposited as a solid DLC coating on the latter. For the doping titanium is simultaneously vaporized from a titanium source by means of a PVD process (Physical Vapour Deposition process), for example by heating a crucible arranged in the reaction chamber and filled with titanium. Alternatively the dopant can also be incorporated into the DLC coating by means of a cathode sputtering process. In this way titanium atoms are incorporated in finely divided form into the DLC coating during its deposition and lead to a doping and thus to an ideal conductivity of the corrosion resistant bipolar plate coated with DLC.

The above described combined CVD/PVD process can also take place without plasma assistance, with the plate 10 additionally being provided with a heater.

The doped DLC coating 44 can also be manufactured in a CVD process in which both the diamond and diamond-like carbon as well as a dopant are deposited chemically from suitable gases onto the uncoated bipolar plate 10.

In addition to titanium, others of the named elements or a combination of them can be used as the doping material.

All the named methods lead to the desired result of a corrosion resistant doped diamond-like carbon and/or diamond coating or a bipolar plate with an adequate conductivity for a high efficiency of the fuel cells.

1. A conductive component for an electrochemical cell comprising a metal part having a doped coating in the form of at least one of a doped diamond coating and a doped diamond-like carbon coating.

2. A component in accordance with claim 1, said doped coating being doped with foreign atoms comprising one of foreign atoms of the main groups of the periodic table of elements, foreign atoms of the side groups of the periodic table of elements and foreign atoms belonging to the rare earths of the periodic table of elements.

3. A component in accordance with claim 1, said doped coating being doped with at least one of the elements Ti, W, Au.

4. A component in accordance with claim 1, said doped coating being doped with at least one of the elements B, Sc, Y, Nb, V, Fe, Cr, Ni, Mn, Zr, Mo, Ta, Hf, Pt, Pd, Re, Ru, Rh, Ir, Ag.

5. A component in accordance with claim 3, said doped coating having between more than 0% and 35% foreign atoms.

6. A component in accordance with claim 3, said doped coating having between 10 and 20% foreign atoms.

7. A component in accordance with claim 4, said doped coating having between more than 0% and 35% foreign atoms.

8. A component in accordance with claim 4, said doped coating having between 10 and 20% foreign atoms.

9. A component in accordance with claim 1, said doped coating having a layer thickness above 0 μm and below 10 μm.

10. A component in accordance with claim 1, said doped coating having a layer thickness in the range from 1 nm to 150 nm.

11. A component in accordance with claim 1, said metal part being formed of a metal selected from the group comprising titanium, stainless steel, steel, steel with no additional alloying element, aluminum, magnesium and an alloy of any of the foregoing.

12. A component in accordance with claim 1 in the form of a bipolar plate of a fuel cell.

13. A method for the manufacture of a conductive component comprising a metal part having a doped coating in the form of at least one of a doped diamond coating and a doped diamond-like carbon coating, wherein said coating is produced by at least one of a CVD and/or a PVD process.

14. A method in accordance with claim 13, wherein said process at least includes a CVD process carried out with plasma assistance.

15. A method in accordance with claim 13, wherein said process at least includes a PVD process carried out with plasma assistance.

16. A method in accordance with claim 13, wherein said at least one process involves the use of at least one reactive gas including carbon as a component thereof for the deposition of said coating.

17. A method in accordance with claim 16, said carbon for said doped coating being available in full by said at least one reactive gas.

18. A method in accordance with claim 13, said method comprising the step of providing a dopant for said doped coating as a component of said at least one process.

19. A method in accordance with claim 18, said dopant being made available as a component of said at least one reactive gas used to form said doped coating.

20. A method in accordance with claim 18 and comprising the step of providing said dopant from a target material comprising said dopant by releasing said dopant from said target material during a PVD process.

21. A method in accordance with claim 13, said at least one process being carried out in a reaction chamber at a pressure of 0.1 to 50000 Pa in said reaction chamber.

22. Use of a component in accordance with claim 1 in an electrochemical cell.

23. Use of a component in accordance with claim 1 as a bipolar plate in a fuel cell.

24. Use of a component in accordance with claim 1 as a bipolar plate in a fuel cell selected from one of the following kinds of fuel cells: PEMFC (Proton Exchange Membrane), DMFC (Direct Methanol Fuel Cell),SOFC (Solid Oxide Fuel Cell), MCFC (Molten Carbide Fuel Cell), PAFC (Phosphoric Acid Fuel Cell) and AFC (Alkaline Fuel Cell).

25. A coating of a metal part for an electrochemical cell, said coating comprising at least one of a doped diamond coating and a doped diamond-like carbon coating.

26. A coating in accordance with claim 25, said doped coating being doped with at least one element selected from the group comprising: Ti, W, Au, B, Sc, Y, Nb, V, Fe, Cr, Ni, Mn, Zr, Mo, Ta, Hf, Pt, Pd, Re, Ru, Rh, Ir, Ag.

27. A coating in accordance with claim 25 when provided on a bipolar plate for a fuel cell.
